(19) United States
(12) Patent Application Publication
(10) Pub. No.: US 2026/0318286 A1
(43) Pub. Date: Oct. 15, 2026

(54) ENERGY GENERATION SYSTEM

(71) Applicant: REPG ENERJI SISTEMLERI SANAYI VE TICARET ANONIM SIRKETI, Istanbul (TR)

(72) Inventor: Hasan AYARTURK, Bursa (TR)

(73) Assignee: REPG ENERJI SISTEMLERI SANAYI VE TICARET ANONIM SIRKETI, Istanbul (TR)

(21) Appl. No.: 19/483,622

(22) PCT Filed: May 9, 2024
(86) PCT No.: PCT/TR2024/050462

§ 371 Date: Nov. 12, 2025

(30) Foreign Application Priority Data
Jun. 9, 2023 (TR) 2023/0066796

(51) Int. Cl. F03G 7/00

(52) U.S. Cl. CPC F03G 7/015; F05B 2210/11; F05B 2220/706; F05B 2260/207

(57) ABSTRACT

An energy generation system generates electrical energy during the movement of a mixture within a closed loop, the closed loop is heated at low temperatures using a heat source, and consists of a fluid in which salt can be dissolved and salt; the energy generation system increases the amount of energy production at low temperatures in closed loop systems.

### CROSS REFERENCE TO RELATED APPLICATIONS

This application is a national stage entry of International Application No. PCT/TR2024/050462, filed on May 9, 2024, which is based upon and claims foreign priority to Turkey Patent Application No. 2023/006796, filed on Jun. 9, 2023, the entire contents of which are incorporated herein by reference.

### TECHNICAL FIELD

The invention relates to an energy generation system for generating electrical energy during the movement of a mixture within a closed loop, which is heated at low temperatures using a heat source, and consists of a fluid in which salt can be dissolved and salt.

### BACKGROUND

Electrical energy is one of the most important energy sources that facilitates the daily life and helps fulfilling many functions that form the basis of modern life. Electrical energy can be produced by using heat energy obtained from the combustion of fossil fuels (coal, natural gas, oil) in thermal energy plants, potential energy of water in hydroelectric power plants, heat energy obtained from the splitting of atomic nuclei through nuclear fission in nuclear power plants, solar energy, wind energy and other renewable energy sources. Another way of generating electricity is by converting the kinetic energy obtained as a result of moving fluids in a closed loop with heat into electrical energy. Osmotic pressure method is used among the methods of generating electricity during the movement of fluids in a closed loop.

Electricity generation by the principle of osmotic pressure is an energy conversion method using a process called osmosis. Osmosis occurs when solutions of two different densities are separated by a semi-permeable membrane. The pure water solution with a lower density tends to diffuse towards the brine solution with a higher density. For electricity generation with the principle of osmotic pressure, the pressure difference between a brine solution with osmotic pressure and a pure water is used. A device called an osmotic power generator generates electricity by using the pressure difference between two compartments separated by a semi-permeable membrane. The compartment exposed to osmotic pressure on the salt water side directs the water molecules passing through the solution to an electric generator, and these water molecules produce electrical energy by creating a current. Electricity generation with the principle of osmotic pressure provides environmental sustainability and energy recovery. In said systems, drive elements which ensure movement such as pumps are used to move liquids. Further, the heat source must be heated at high temperatures to ensure the movement of fluids within the system. In this case, part of the energy produced is used for the operation of the system. This leads to a decrease in the amount of energy produced.

Application No. WO2010065791 describes an osmotic energy storage system. In said system, a pump is used to ensure the movement of fluids. This causes the system to operate at high temperatures. The reason being, the energy required for the operation of the pump can be obtained at high temperatures. This leads to a decrease in the amount and efficiency of energy produced.

As a result, all the above-mentioned problems have made it imperative to make an innovation in the relevant technical field.

### SUMMARY

The present invention relates to an energy generation system for eliminating the above-mentioned disadvantages and bringing the new advantages to the relevant technical field.

One object of the invention is to introduce an energy generation system to increase the amount of energy production at low temperatures in closed loop systems.

In order to achieve all the objects mentioned above and arising from the detailed explanation below, the present invention is an energy generation system for generating electrical energy during the movement of a mixture within a closed loop, which is heated at low temperatures using a heat source, and consists of a fluid in which salt can be dissolved and salt. Accordingly, it comprises a first chamber containing said mixture heated from a heat entry point using said heat source; a boiler placed above the first chamber as the location to which the mixture heated in said first chamber is conveyed by means of bubble pump, an energy generation unit in which a first mixture which evaporates from the mixture heated in said boiler into a gaseous phase is transmitted to generate energy; a third chamber for collecting the first mixture, which becomes pure by condensing in said energy generation unit, a heat exchanger to which a second mixture remaining in liquid phase in the boiler is transmitted for cooling; a cooler having a first heat exit point thereon, to which the second mixture contained in said heat exchanger is transmitted for cooling; a second chamber to which the second mixture, the density of which increases in said cooler, is transmitted according to the principle of equal containers; a semi-permeable membrane placed between the second chamber and the third chamber to ensure that the first mixture passes from the third chamber, which is a less dense environment, to the second chamber, which is a more pressurized and denser environment than the third chamber, by osmotic pressure.

A possible embodiment of the invention is characterized in that the fluid is provided in organic form.

Another possible embodiment of the invention is characterized in that the fluid is provided in inorganic form.

Another possible embodiment of the invention is characterized in that the fluid has a low evaporation temperature.

Another possible embodiment of the invention is characterized in that the semi-permeable membrane is provided in a form that allows only the solvent in the fluid to pass through, depending on the type of fluid used for the mixture.

Another possible embodiment of the invention is characterized in that the energy generation unit is located between the boiler and the third chamber.

Another possible embodiment of the invention is characterized in that the energy generation unit includes a turbine and a first condenser for condensing the first mixture expanding in said turbine.

Another possible embodiment of the invention is characterized in that the first condenser comprises a second heat exit point.

Another possible embodiment of the invention is characterized in that the energy generation unit includes a first injector, an MHD converter connected with said first injector, a second condenser for condensing the first mixture expanding in said MHD converter, and a fourth chamber for the storage of the first mixture connected to said second condenser.

Another possible embodiment of the invention is characterized in that said second condenser comprises a third heat exit point.

Another possible embodiment of the invention is characterized in that the fourth chamber is placed in connection with the third chamber.

Another possible embodiment of the invention is characterized in that the energy generation unit includes a second injector, an EHD converter connected with said second injector, a third condenser for condensing the first mixture expanding in said EHD converter, and a fifth chamber for the storage of the first mixture connected to said third condenser.

Another possible embodiment of the invention is characterized in that the third condenser comprises a fourth heat exit point.

Another possible embodiment of the invention is characterized in that the fifth chamber is placed in connection with the third chamber.

### BRIEF DESCRIPTION OF THE DRAWINGS

FIG. 1 shows a representative view of an energy generation system comprising a turbine.

FIG. 2 shows a representative view of an energy generation system comprising an MHD converter.

FIG. 3 shows a representative view of an energy generation system comprising an EHD converter.

### REFERENCE NUMERALS IN THE DRAWINGS

100 Energy generation system
1 Heat entry point
2 First chamber
3 Boiler
4 Third chamber
5 Heat Exchanger
6 First heat exit point
7 Cooler
8 Second chamber
9 Semi-permeable membrane
10 Energy generation unit
11 Turbine
12 First condenser
13 Second heat exit point
14 First injector
15 MHD converter
16 Second condenser
17 Fourth chamber
18 Third heat exit point
19 Second injector
20 EHD converter
21 Third condenser
22 Fifth chamber
23 Fourth heat exit point
24 Mixture
25 First mixture
26 Second mixture

### DETAILED DESCRIPTION OF THE EMBODIMENTS

In this detailed description, the subject of the invention is explained by way of example only for a better understanding of the subject, which shall not create any limiting effect.

The invention relates to an energy generation system (100) for generating electrical energy during the movement of a mixture (24) within a closed loop, which is heated at low temperatures using a heat source, and consists of a fluid in which salt can be dissolved and salt. Here, closed loop refers to the continuous circulation of a working fluid (usually a gas or liquid) in a closed cycle without being released to the external environment. In a possible embodiment of the invention, said fluid is provided in organic form. In a possible embodiment of the invention, the fluid is provided in inorganic form. Said fluid has a low evaporation temperature. In a possible embodiment of the invention, it is preferred to use ammonia as a fluid. The reason being, ammonia has the ability to dissolve all salts even at a low temperature of −20°.

Energy generation system (100) comprises a first chamber (2) containing the mixture (24) heated from a heat entry point using said heat source. There is a boiler (3) placed above the first chamber (2) as the location to which the mixture (24) heated in said first chamber (2) is conveyed by means of bubble pump.

Energy generation system (100) comprises an energy generation unit (10) in which a first mixture (25) which evaporates from the mixture (24) heated in said boiler (3) into a gas phase is transmitted to generate energy. Here, the first mixture (25) comprises components that evaporate in the main mixture (24) into the gas phase. The energy generation system (100) includes a third chamber (4) for collecting the first mixture (25), which becomes pure by condensing in said power generation unit (10). The energy generation unit (10) is placed between the boiler (3) and said third chamber (4).

In a possible embodiment of the invention, as said energy generation unit (10), it is preferred to use a turbine (11) and a first condenser (12) for condensing the first mixture (25) expanding in said turbine (11). Said first condenser (12) comprises a second heat exit point (13) In an alternative embodiment of the invention, it is preferred to use as the energy generation unit (10) a first injector (14), an MHD converter (15) connected to said first injector (14), a second condenser (16) for condensing the first mixture (25) expanding in said MHD converter (15), and a fourth chamber (17) for storing the first mixture (25) connected to said second condenser (16). Said second condenser (16) comprises a third heat exit point (18). Said fourth chamber (17) is placed in connection with the third chamber (4).

In another alternative embodiment of the invention, it is preferred to use as the energy generation unit (10) a second injector (19), an EHD converter (20) connected to said second injector (19), a third condenser (21) for condensing the first mixture (25) expanding in said EHD converter (20), and a fifth chamber (22) for storing the first mixture (25) connected to said third condenser (21). Said third condenser (21) comprises a fourth heat exit point (23). Said fifth chamber (22) is placed in connection with the third chamber (4).

The energy generation system (100) includes a heat exchanger (5) to cool a second mixture (24) remaining in the liquid phase in the boiler (3). Here, the second mixture (24) comprises the components of the original mixture (24) remaining in the liquid phase. There is a cooler (7) having a first heat exit point (6) thereon, to which the second mixture (24) contained in said heat exchanger (5) is transmitted for cooling. The heat of the second mixture (24) cooled in said cooler (7) is discharged from the first heat exit point (6). There is a second chamber (8) to which the second mixture (24), the density of which increases in the cooler (7), is transmitted according to the principle of equal containers. The energy generation system (100) comprises a semi-permeable membrane (9) placed between the second chamber (8) and the third chamber (4) to ensure that the first mixture (25) passes from the third chamber (4), which is a less dense environment, to the second chamber (8), which is a more pressurized and denser environment than the third chamber (4), by osmotic pressure. Said semi-permeable membrane (9) is provided in a form that allows only the solvent in the fluid to pass through, depending on the type of fluid used for the mixture (24).

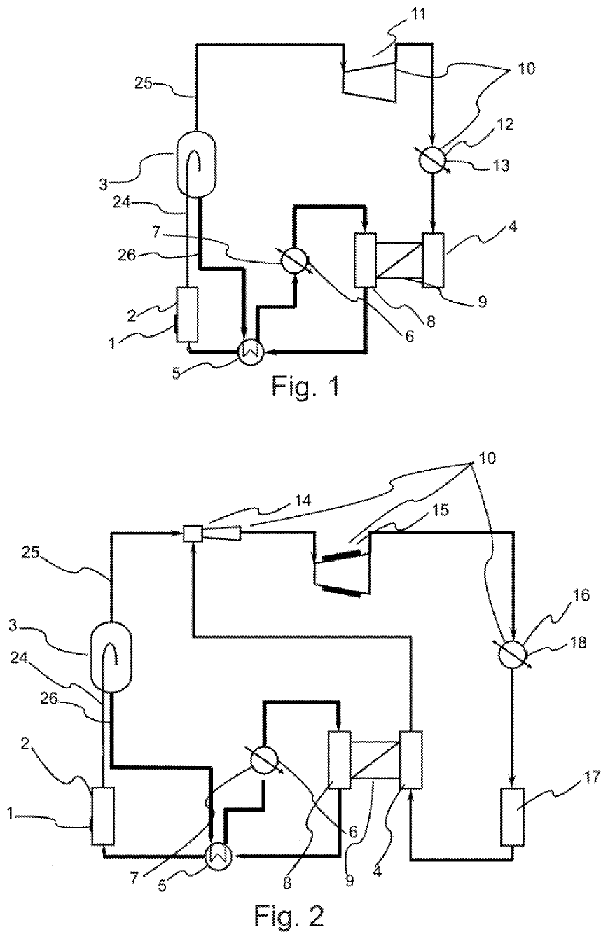

An example embodiment of the invention is shown in FIG. 1. Referring to FIG. 1, as a result of heating the first chamber (2) using the heat source, the boiling process of the mixture (24) in the first chamber (2) takes place. With this boiling process, the mixture (24) is conveyed to the boiler (3) by the bubble pump method, which is the principle of moving a liquid from one place to another without the need for any mechanical energy. With the evaporation event taking place in the upper part of the boiler (3), it is ensured that a first mixture (25) evaporating from the mixture (24) is transmitted to the turbine (11). It is ensured that the second mixture (24) remaining from the mixture (24) in the boiler (3) is transferred to the heat exchanger. The heat exchanger (5) allows a mixture (24) to be transmitted by transferring heat from one environment to another. It is ensured that the second mixture (24), the partial heat transfer of which is achieved in the heat exchanger (5), is transferred to the cooler (7). It is ensured that the second mixture (24), the density of which increases in the cooler (7), is transferred to the second chamber (8) according to the equal containers principle. The second chamber (8) is provided to be connected with the heat exchanger. It is ensured that the mixture accumulated in the second chamber (8) is transferred to the heat exchanger. The mixture (24) returning to the heat exchanger (5) is transmitted to the first chamber (2) to repeat the cycle.

It is ensured that energy is generated depending on the movement of the first mixture (25) transmitted to the turbine in the turbine (11). It is ensured that in the turbine (11), the first expanding mixture (25) is condensed and transmitted to the first condenser (12). It is ensured that the first mixture (25) is converted into its pure form in the first condenser (12). It is ensured that the first mixture (25) converted into pure form is transmitted to the third chamber (4). It is ensured that the first mixture (25), which has become pure, is transmitted from the third chamber (4), which is a less dense environment, to the second chamber (8), which is a more pressurized and very dense environment, by means of a semi-permeable membrane (9) placed between the third chamber (4) and the second chamber (8), depending on the osmotic pressure principle. Thus, it is possible to recombine the first mixture (25) with the second mixture (24) without the use of a pump. This ensures that energy is produced continuously without using energy in a closed cycle. Since there is no need for the energy consumption of the pump, the system has the ability to operate at low temperatures.

Another example embodiment of the invention is shown in FIG. 2. Referring to FIG. 2, as a result of heating the first chamber (2) using the heat source, the boiling process of the mixture (24) in the first chamber (2) takes place. With this boiling process, the mixture (24) is conveyed to the boiler (3) by the bubble pump method, which is the principle of moving a liquid from one place to another without the need for any mechanical energy. With the evaporation event taking place in the upper part of the boiler (3), it is ensured that a first mixture (25) evaporating from the mixture (24) is sucked by means of the first injector (14). It is ensured that the second mixture (24) remaining from the mixture (24) in the boiler (3) is transferred to the heat exchanger. The heat exchanger (5) allows a mixture (24) to be transmitted by transferring heat from one environment to another. It is ensured that the second mixture (24), the partial heat transfer of which is achieved in the heat exchanger (5), is transferred to the cooler (7). It is ensured that the second mixture (24), the density of which increases in the cooler (7), is transferred to the second chamber (8) according to the equal containers principle. The second chamber (8) is provided to be connected with the heat exchanger. It is ensured that the mixture accumulated in the second chamber (8) is transferred to the heat exchanger. The mixture (24) returning to the heat exchanger (5) is transmitted to the first chamber (2) to repeat the cycle.

The first mixture (24) (25) passes through the first injector (14) through the MHD converter (15). It comprises magnets that are connected to the upper and lower parts of the MHD converter (15). When a conductor passes through the magnetic field created by magnets, an electric current is formed thereon and electricity is produced from this current. It is ensured that the expanded first mixture (25) exiting the MHD converter (15) is transmitted to the second condenser (16) for condensation. It is ensured that the first mixture (25) is converted into its pure form in the second condenser (16). It is ensured that the first mixture (25) converted into pure form is transmitted to the fourth chamber (17). It is ensured that the first mixture (25) accumulated in the fourth chamber (17) is transmitted to the third chamber (4). The first injector (14) is placed in connection with the third chamber (4). The lower part of the first injector has the ability to vacuum. For this reason, the first mixture (25) from the boiler (3) is pressurized. The first mixture (25) transmitted from the third chamber (4) to the first injector (14) is vacuumed. Thus, the first mixture (25) collected in the fourth chamber (17) is sucked by the first injector (14) through the third chamber (4) and the closed loop is circulated continuously. This reduces the amount of energy required for the operation of the system and helps to increase the amount of energy produced. It is ensured that the second mixture (24) (26) is transmitted from the third chamber (4), which is a less dense environment, to the second chamber (8), which is a more pressurized and very dense environment, by means of a semi-permeable membrane (9) placed between the third chamber (4) and the second chamber (8), depending on the osmotic pressure principle. Thus, it is possible to recombine the first mixture (25) with the second mixture (24) without the use of a pump. This ensures that energy is produced continuously without using energy in a closed cycle. In said system, it is preferred to use salt as a solute in the mixture (24). Since steam is constantly coming from the left side of the closed loop to the right side, the density decreases and thus a pressure difference occurs by creating a less dense and very dense environment. In this case, electricity is generated by means of the MHD converter (15) using the electrical conductivity of the salty mixture (24).

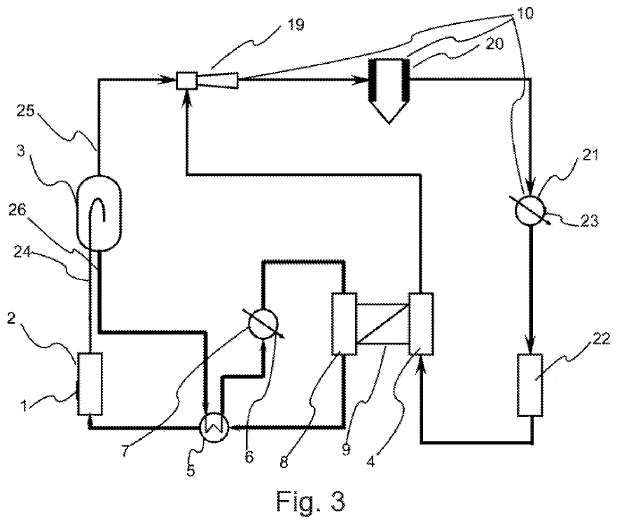

Another example embodiment of the invention is shown in FIG. 3. Referring to FIG. 3, as a result of heating the first chamber (2) using the heat source, the boiling process of the mixture (24) in the first chamber (2) takes place. With this boiling process, the mixture (24) is conveyed to the boiler (3) by the bubble pump method, which is the principle of moving a liquid from one place to another without the need for any mechanical energy. With the evaporation event taking place in the upper part of the boiler (3), it is ensured that a first mixture (25) evaporating from the mixture (24) is sucked by means of the second injector (19). It is ensured that the second mixture (24) remaining from the mixture (24) in the boiler (3) is transferred to the heat exchanger. The heat exchanger (5) allows a mixture (24) to be transmitted by transferring heat from one environment to another. It is ensured that the second mixture (24), the partial heat transfer of which is achieved in the heat exchanger (5), is transferred to the cooler (7). It is ensured that the second mixture (24), the density of which increases in the cooler (7), is transferred to the second chamber (8) according to the equal containers principle. The second chamber (8) is provided to be connected with the heat exchanger. It is ensured that the mixture accumulated in the second chamber (8) is transferred to the heat exchanger. The mixture (24) returning to the heat exchanger (5) is transmitted to the first chamber (2) to repeat the cycle. The first mixture (25) is transmitted through the second injector (19) to the EHD converter (20). The EHD converter (20) comprises two electrodes. The electrodes are connected to a source supplied with high voltage. The high voltage applied between the electrodes allows the ionization process to start in the fluid. This ionization process ensures the separation of fluid molecules into positive and negative ions. The ions formed move under the influence of the electric field and create a current in the first mixture (25). This moving current acts as an electrical power generator, allowing electrical energy to be generated.

It is ensured that the expanded first mixture (25) exiting the EHD converter is transmitted to the third condenser (21) for condensation. It is ensured that the first mixture (25) is converted into its pure form in the third condenser (21). It is ensured that the first mixture (25) converted into pure form is transmitted to the fourth chamber (22). It is ensured that the first mixture (25) accumulated in the fifth chamber (22) is transmitted to the third chamber (4). The second injector (19) is placed in connection with the third chamber (4). The lower part of the second injector has the ability to vacuum. For this reason, the first mixture (25) from the boiler (3) is pressurized. The first mixture (25) transmitted from the third chamber (4) to the first injector (14) is vacuumed. Thus, the first mixture (25) collected in the fifth chamber (22) is sucked by the second injector (19) through the third chamber (4) and the closed loop is circulated continuously. This reduces the amount of energy required for the operation of the system and helps to increase the amount of energy produced. In said system, it is preferred to use alkali metals as a solute in the mixture (24). In a preferred embodiment of the invention, ammonia is used as an alkali metal. Since steam is constantly coming from the left side of the closed loop to the right side, the density decreases and thus a pressure difference occurs by creating a less dense and very dense environment. In this case, electricity is generated by means of the EHD converter (20) using the electrical conductivity of the salty mixture (24). It is ensured that the second mixture (24) (26) is transmitted from the third chamber (4), which is a less dense environment, to the second chamber (8), which is a more pressurized and very dense environment, by means of a semi-permeable membrane (9) placed between the third chamber (4) and the second chamber (8), depending on the osmotic pressure principle. Thus, it is possible to recombine the first mixture (25) with the second mixture (24) without the use of a pump. This ensures that energy is produced continuously without using energy in a closed cycle.

The scope of protection of the invention is specified in the appended claims and cannot be limited to what is described for illustrative purposes in this detailed description. It is clear that a person skilled in the art can produce similar embodiments in the light of what is explained above, without deviating from the main theme of the invention.

1. An energy generation system for generating electrical energy during the movement of a mixture within a closed loop, the closed loop is heated at low temperatures using a heat source, and consists of a fluid in which salt can be dissolved and salt, the closed loop comprises a first chamber containing said mixture heated from a heat entry point using the heat source; a boiler placed above the first chamber as the location to which the mixture heated in the first chamber is conveyed by means of bubble pump; an energy generation unit in which a first mixture which evaporates from the mixture heated in the boiler into a gaseous phase is transmitted to generate energy; a third chamber for collecting the first mixture which becomes pure by condensing in the energy generation unit;
a heat exchanger to which a second mixture remaining in liquid phase in the boiler is transmitted for cooling; a cooler having a first heat exit point thereon, to which the second mixture contained in the heat exchanger is transmitted for cooling; a second chamber to which the second mixture, the density of which increases in the cooler, is transmitted according to the principle of equal containers;
a semi-permeable membrane placed between the second chamber and the third chamber to ensure that the first mixture passes from the third chamber, which is a less dense environment, to the second chamber, which is a more pressurized and denser environment than the third chamber, by osmotic pressure.

2. An energy generation system according to claim 1, wherein the fluid is provided in organic form.

3. An energy generation system according to claim 1, wherein the fluid is provided in inorganic form.

4. An energy generation system according to claim 1, wherein the fluid has a low evaporation temperature.

5. An energy generation system according to claim 1, wherein the semi-permeable membrane is provided in a form that allows only the solvent in the fluid to pass through, depending on the type of fluid used for the mixture.

6. An energy generation system according to claim 1, wherein the energy generation unit is placed between the boiler and the third chamber.

7. An energy generation system according to claim 1, wherein the energy generation unit includes a turbine and a first condenser for condensing the first mixture expanding in said turbine.

8. An energy generation system according to claim 7, wherein the first condenser comprises a second heat exit point.

9. An energy generation system according to claim 1, wherein the energy generation unit comprises a first injector, an MHD converter connected to the first injector, a second condenser for condensing the first mixture expanding in the MHD converter, and a fourth chamber for storing the first mixture connected to the second condenser.

10. An energy generation system according to claim 9, wherein the second condenser comprises a third heat exit point.

11. An energy generation system according to claim 9, wherein the fourth chamber is placed in connection with the third chamber.

12. An energy generation system according to claim 1, wherein the energy generation unit comprises a second injector an EHD converter connected to the second injector, a third condenser for condensing the first mixture expanding in said EHD converter, and a fifth chamber for storing the first mixture connected to the third condenser.

13. An energy generation system according to claim 12, wherein the third condenser comprises a fourth heat exit point.

14. An energy generation system according to claim 12, wherein the fifth chamber is placed in connection with the third chamber.
